(19) United States
(12) Patent Application Publication
(10) Pub. No.: US 2008/0177648 A1
(43) Pub. Date: Jul. 24, 2008

(54) CONFIDENCE BASED WEB SERVICE APPLICATION ASSEMBLY

(75) Inventors: Ronald Patrick Doyle, Raleigh, NC (US); David Louis Kaminsky, Chapel Hill, NC (US)

Correspondence Address: STEVENS & SHOWALTER, L.L.P., BOX IBM, 7019 CORPORATE WAY, DAYTON, OH, 45459-4238, US

(73) Assignee: INTERNATIONAL BUSINESS MACHINES CORPORATION, Armonk, NY (US)

(21) Appl. No.: 11/624,803

(22) Filed: Jan. 19, 2007

(51) Int. Cl. G06Q 40/00; G06Q 10/00

(52) U.S. Cl. 705/35; 705/1

(57) ABSTRACT

A composite application may be assembled from one or more component services, and at least one component service of the composite application is monitored. A determination is made of a probability of breach for each monitored component service of the composite application and an economic metric of the composite application is computed based upon each determined probability of breach. The economic metric may also consider and expected warranty cost provided to a requestor of the composite application. At least one parameter associated with the composite application or monitored services is then adjusted to maximize overall composite application performance based upon the economic metric.

### BACKGROUND OF THE INVENTION

The present invention relates to systems, computer program products and computer methods for providing confidence-based service application assembly.

Internet-based Web applications may be comprised of a number of services that are linked or otherwise interconnected together so that the resulting composite application appears seamless to the user. In this regard a composite application may include any number of components services which are selected either statically or dynamically to implement prescribed roles corresponding to the composite application.

Each component service of the composite application may have a price and penalty associated with its use in the composite application. Additionally, certain services will be more reliable than others in terms of successfully implementing its role in the corresponding composite application, regardless of its price for use or penalty for failure to implement its role. The price, penalty and reliability costs of the component services are typically aggregated into the overall cost of the composite application and that cost is passed on to the user.

### BRIEF SUMMARY OF THE INVENTION

According to an aspect of the present invention, a computer-implemented method of assembling an application comprises monitoring at least one component service of a composite application, determining a probability of breach for at least one monitored component service of the composite application, and computing an economic or performance metric corresponding to the composite application based upon at least one determined probability of breach. The method may further comprise performing an action if a determination is made that the economic or performance metric of the composite application should be improved, the action comprising at least one of adjusting at least one parameter associated with the composite application or monitored service, or replacing one or more component services utilized by the composite application.

According to another aspect of the present invention, a computer program product to monitor an application assembly comprises a computer usable medium having computer usable program code embodied therewith. The computer usable program code comprises computer usable program code configured to monitor at least one component service of a composite application, computer usable program code configured to determine a probability of breach for at least one monitored component service of the composite application, and computer usable program code configured to compute an economic or performance metric corresponding to the composite application based upon at least one determined probability of breach. The computer program product may further comprise computer usable program code configured to perform an action if a determination is made that the economic or performance metric of the composite application should be improved, the action comprising at least one of adjusting at least one parameter associated with the composite application or monitored service, or replacing one or more component services utilized by the composite application.

According to yet another aspect of the present invention, a system to monitor an application comprises a module to monitor at least one component service of a composite application, a module to determine a probability of breach for at least one monitored component service of the composite application, and a module to compute an economic or performance metric corresponding to the composite application based upon at least one determined probability of breach. The system may further comprise a module to perform an action if a determination is made that the economic or performance metric of the composite application should be improved, the action comprising at least one of an adjustment of at least one parameter associated with the composite application or monitored service, or a replacement of one or more component services utilized by the composite application.

### BRIEF DESCRIPTION OF THE SEVERAL VIEWS OF THE DRAWINGS

FIG. 1 is a block diagram of a system that may be used to implement a confidence-based application assembly;

FIG. 2 is a flowchart illustrating an exemplary method of addressing a detected problem service of an application assembly;

FIG. 3 is a flowchart illustrating a method of monitoring an application assembly;

FIG. 4 is a diagram illustrating several exemplary actions that may be taken in response to a detected problems service of an application assembly;

FIG. 5 is a flowchart illustrating a method of monitoring an application assembly;

FIG. 6 is a block diagram of an exemplary system for monitoring an application assembly; and

FIG. 7 is a block diagram of an exemplary system for monitoring an application assembly.

### DETAILED DESCRIPTION OF THE INVENTION

The various aspects of the present invention may be embodied as computer methods, systems or computer program products. Also, various aspects of the present invention may take the form of an entirely hardware embodiment, an entirely software embodiment (including firmware, resident software, micro-code, etc.) or an embodiment combining software and hardware, wherein the embodiment or aspects thereof may be generally referred to as a “circuit,” “module” or “system.” Furthermore, the various aspects of the present invention may take the form of a computer program product on a computer-usable storage medium having computer-usable program code embodied in the medium.

The software aspects of the present invention may be stored, implemented and/or distributed on any suitable computer usable or computer readable medium(s), including but not limited to, any medium that can contain, store, communicate, propagate or transport the program for use by or in connection with an instruction execution system of a corresponding processing device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium.

More specific examples of the computer usable or computer readable medium comprise for example, an electrical connection having one or more wires, a swappable intermediate storage medium such as floppy drive, tape drive, external hard drive, a portable computer diskette, a hard disk, a random access memory (RAM), a read-only memory (ROM), an erasable programmable read-only memory (EPROM or Flash memory), a portable compact disc read-only memory (CD-ROM) or digital video disk (DVD), an optical fiber or storage device, or a transmission media such as those supporting the Internet or an intranet. The computer-usable or computer-readable medium may also comprise paper or another suitable medium upon which the program is printed, as the program can be electronically captured, for example, via optical scanning of the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wireline, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

In the detailed description, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of various embodiments of the present invention.

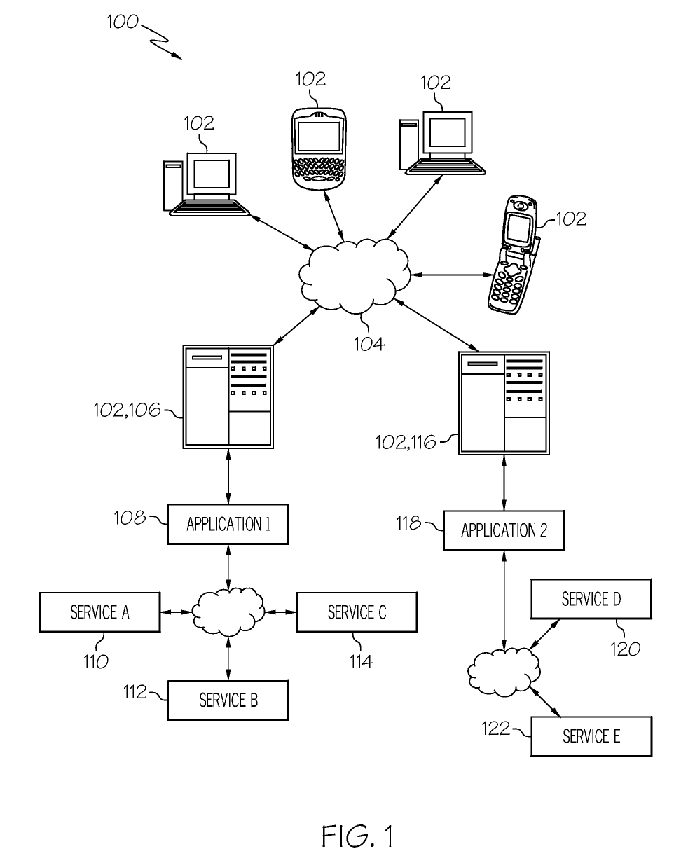

Referring now to the drawings and particularly to FIG. 1, an exemplary system 100 is illustrated, which may be utilized to assemble and/or monitor composite applications that are assembled from component services. The system 100 includes a plurality of processing devices 102, which may comprise four example, servers, personal computers, notebook computers, transactional systems, appliance or pervasive computing devices such as personal data assistants (PDA), palm computers, cellular access processing devices, special purpose computing devices and/or other devices capable of interacting with the system 100.

The various processing devices 102 may communicate across a network 104 such as the Internet. Thus, the various processing devices 102 may be supported by networking components that interconnect the various hardware and/or software processing devices 102, including for example, routers, hubs, firewalls, network interfaces wired or wireless communications links and corresponding interconnections. Moreover, the network 104 may comprise connections using one or more intranets, extranets, local area networks (LAN), wide area networks (WAN), wireless networks (WIFI), the Internet, including the world wide web, and/or other arrangements for enabling communication between the processing devices 102, either real time or otherwise, e.g., via time shifting, batch processing, etc.

In an illustrative example, the network 104 may include the Internet, and a select one of the processing devices 102 may comprise a business server 106. The business server 106 hosts a first composite application 108, also referred to in the Figure as Application 1, which is assembled to include three component services 110, 112, 114, also designated as Service A, Service B and Service C, respectively. The first composite application 108 may comprise, for example, an on-line store or other web-based application, an intermediate application that interacts with other applications within the business server 106 or otherwise across the network 104, or any other application that can be assembled from one or more services.

Moreover, each of the component services 110, 112 and 114 may be implemented on the business server 106 or the component services 110, 112, 114 may be distributed to one or more additional processing devices 102 across the network 104. The various component services 110, 112, 114 may conduct transactions with the first composite application 108 itself, with other services of the first composite application 108 or with other processes implemented on processing device 102 across the network 104.

Continuing with the above example, assume that the first composite application 108 comprises an on-line store and a customer on one of the processing devices 102 wishes to conduct a transaction by interacting with the on-line store to purchase an item. Under this arrangement, Service A may provide a search function to locate items available for sale at the on-line store, Service B may implement an electronic shopping cart and Service C may process payments when a customer checks out of the store with items in their shopping cart. As the customer interacts with the on-line store, the corresponding services 110, 112, 114 transact with the composite application 108 as their respective roles are required to service the customer interaction.

Assume that the customer has selected an item and is ready to check out the item from the shopping cart. The first composite application 108 transacts with Service C to process the customer's payment, e.g., which is received via a credit card. In order to process the payment, it may be necessary for Service C to communicate with a third party, such as a corresponding credit card company, to verify financial information and to receive payment on behalf of the customer for the item(s) purchased by the customer. As one illustrative example, assume that Service C communicates across the network 104 to a third party credit card company server 116. Server 116 is thus an independent party to the transaction between the customer and the business supported by the business server 106.

The server 116 may process the communication from Service C using a second composite application 118, designated herein as Application 2. The second composite application 118 may be comprised of two component services 120, 122, also designated herein as Service D and Service E. For example, Service D may locate the account of the credit card holder wishing to conduct the transaction, and Service E may process the payment requested by Service C. When Service C receives the payment from Service E, the first composite application 108 may conclude the transaction with the customer.

In assembling the services 110, 112, 114, it may be that several candidate services may be available, each of which may perform a desired role, e.g., implement a function, task or other process required by the first composite application 108. For example, there may be several candidate services available to the first composite application 108 that can implement the role of the shopping cart of Service B. These candidate shopping cart services may be different versions of a given shopping cart, they may be originated from different sources, e.g., different service providers, including third party service providers, or may otherwise be obtained or otherwise available for use from any suitable sources. Accordingly, the first composite application 108 and its associated component services 110, 112, 114 may be monitored for performance and system operation may be modified to optimize the first composite application 108 as described in greater detail herein.

Keeping with the above example, it may be that the business that operates the business server 106 purchases, rents, leases or otherwise contracts with a software provider to acquire the use of the first composite application 108. The software provider may be a software intermediate that assembles the first composite application 108 by developing and/or acquiring rights to use each of the component services 110, 112, 114, e.g., from third party service providers, from proprietary sources or from other resources. Thus, the software provider may make certain guarantees, warranties or other assurances to the business as to the fitness of the first composite application 108. The software provider may thus, also require certain guarantees, warranties or other assurances from the various component services.

The above example is presented by way of illustration, and not by way of limitation, of a system including composite application assemblies. In practice, the composite application assemblies may be constructed from any number of services. Moreover, the composite applications and the corresponding services may implement any number of diverse processing tasks and may be provided from one or multiple sources.

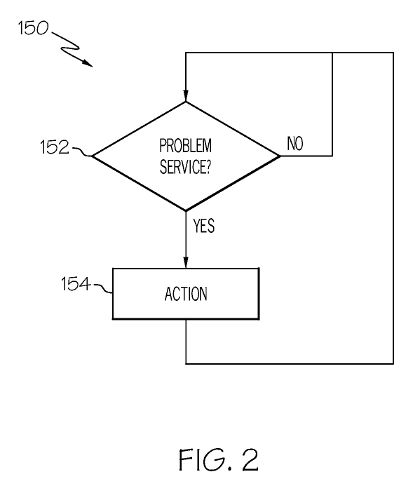

Referring to FIG. 2, a flowchart 150 illustrates an exemplary method of monitoring and addressing issues related to an application assembly of services. The system monitors the composite application and the component services. If a problem service is detected at 152, an appropriate action is performed at 154.

As in all systems, certain candidate component services will provide more reliable operations than other services. Thus, each candidate service may have a different associated failure rate. Further, each candidate service may have different system requirements, different computational costs including processing overhead, and other associated characteristics that may affect the selection of the candidate service. Accordingly, one exemplary way to gauge the effectiveness of the composite application and to determine the effectiveness of the corresponding component services is to apply economic metrics to the system, e.g., by using determined attributes to maximize gross profit and/or return on investment and/or to achieve some other measure of business or performance measures.

In order to establish an economic model to monitor the composite application and its component services, it may be assumed that a price is paid to the composite application for completion of a corresponding predetermined transaction, e.g., with a customer surfing to the web store of the business and purchasing an item in their on-line store. For example, a “per-use” economic model may be derived, in which the corresponding business “pays” for the use of the composite application. The payment price may be some measure of actual monetary charges to the business for use of the composite application. Alternatively, the payment price may be specified in some arbitrary units used for purposes of implementing the economic metrics on a conceptual level.

Additionally, a rule may be established that no payment is received by the composite application if a transaction cannot be completed. Moreover, a penalty may be paid by the composite application for failure to complete the corresponding transaction. The penalty may be absolute, or triggered by exceeding some predetermined service guarantee. As such, the composite application may have a price associated with its use, a service guarantee, e.g., less than a 0.5% failure rate, and a failure of service penalty that may be paid for failure of the composite application to successfully complete a transaction, e.g., in excess of its service guarantee.

In an analogous manner, each component service may be assigned a price that is paid to that service; e.g., by the composite application, for successfully completing a transaction associated with a corresponding defined role on behalf of the composite application and a penalty that must be paid by the service for failure to complete a transaction associated with its role on behalf of the composite application.

One exemplary way to factor reliability as part of the economic metrics is to consider a probability of breach (POB) for each component service. The probability of breach represents a measure of the likelihood that a corresponding service will be able to complete a transaction associated with the implementation of its role as part of the composite application. Thus, the composite application may compute its overall probability of breach as a function of the probability of breach of its individual service components.

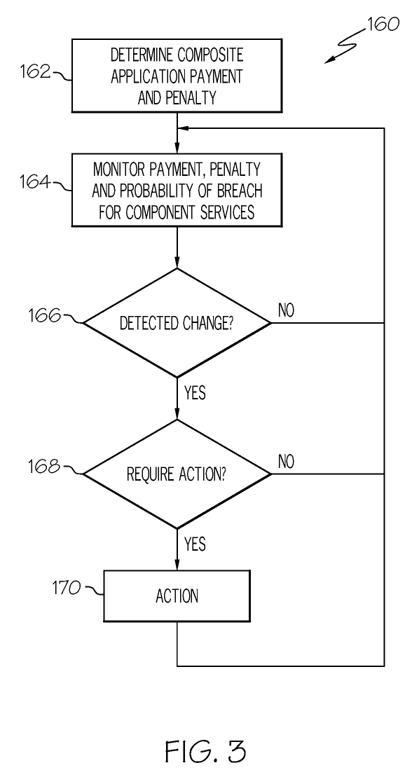

Referring to FIG. 3, a flow chart 160 illustrates an exemplary system and method for monitoring an application assembly. A determination is made to set a composite application payment and penalty at 162. The payment, penalty and/or probability of breach for component services are monitored at 164. A decision is made at 166 as to whether or not a change has been detected in the monitored parameters, e.g., payment, penalty and/or probability of breach for component services. If no changes have been detected, the system continues to monitor the payment, penalty and/or probability of breach for the component services at 164. If a change has been detected, then a decision is made at 168 as to whether or not the detected change requires action.

For example, if the probability of breach for a given service changes in a manner that makes that service more reliable, then there may be no need for a change. Moreover, detected changes that are nominal or that do not otherwise affect the selection of services or the price, penalty or warranty offered by the composite application may not require action. Thus, monitoring at 164 may resume. If it is determined that the detected change requires attention, then a suitable action is taken at 170.

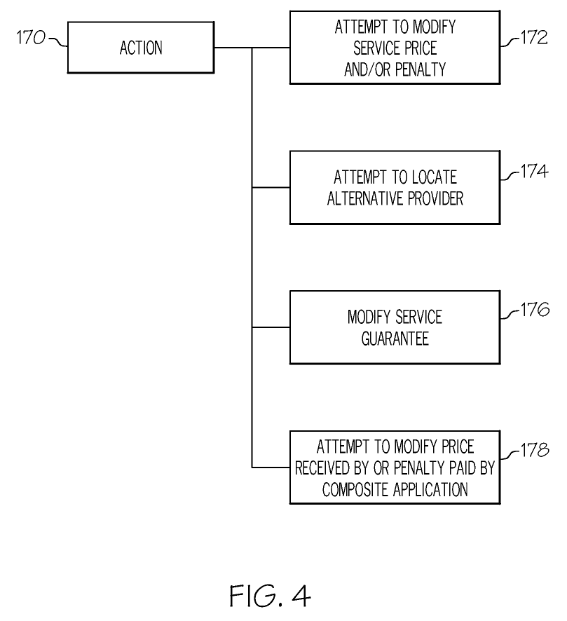

Referring to FIG. 4, some exemplary actions which may be implemented at 170 are illustrated. Exemplary actions include for example, attempting to modify the price and/or penalty of one or more component services at 172. For example, a detected problematic service may be addressed by reducing the price paid to that service and/or by increasing the penalty paid by the service for failure to complete is assigned transaction. Another exemplary action is to attempt to locate an alternative service at 174. For example, a composite application may have multiple candidate services available, which are each capable of performing a predefined role within the composite application. Accordingly, a service can be replaced with a new candidate service that improves profit of the composite application. Yet another exemplary action is to reduce the service guarantees provided by the composite application at 176. Still another exemplary action is to modify the price charged by the composite service and/or to modify the penalty paid by the composite application for failure to complete its transaction at 178.

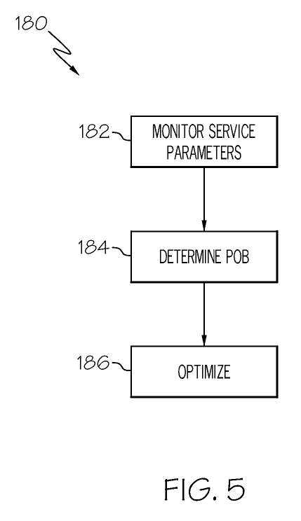

Referring to FIG. 5, a system and method 180 are illustrated for optimizing a composite assembly. The system and method 180 may be utilized as an initial process to build a composite application, such as in the selection of component services, as well as in the maintained operation of the composite application, e.g., to maintain the overall profitability of the composite application. Service parameters are monitored at 182. Exemplary service parameters may comprise, for example, the price and penalty of each monitored service. The probably of breach for each of the monitored component services is determined at 184. Based upon the computed probabilities of breach and/or the monitored parameters, an optimization of the composite application is performed at 186.

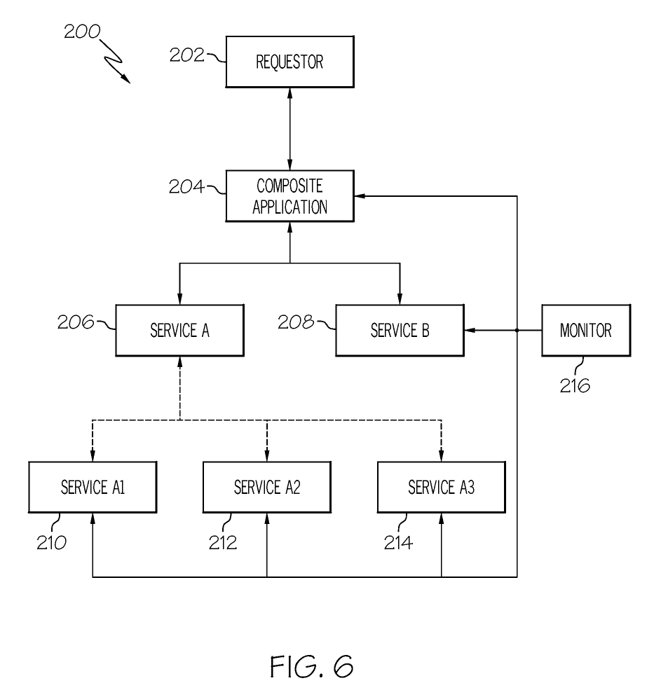

Referring to FIG. 6, a system 200 is illustrated to show by way of example, an implementation of a composite application assembly and/or monitoring of a composite application assembly. A requester 202 has a need to transact with a composite application 204. The composite application 204 is comprised of (or assembled from) a first service 206, designated herein as Service A, and a second service 208, designated herein as a Service B, which may be necessary to implement roles required to fulfill the transaction with the requester 202. The first service 206 may be implemented by a first candidate service 210, designated herein as Service A1, a second candidate service 212, designated herein as Service A2 or a third candidate component service 214, designated herein as Service A3.

A monitor module 216 monitors the composite application 204, including the first candidate service 210, the second candidate service 212, the third candidate component service 214 and the second service 208 in order to optimize an economic or performance metric. In this regard, the economic or performance metric comprises, for example, a measure of profit maximization, return on investment, a combination of both profit and return on investment or some other suitable measure.

Assume that initially, it is determined that the first service 206 should be implemented by the first candidate service 210, and that the third candidate component service 214 is too costly or has a probability of breach that is outside an acceptable target range to be deemed a viable alternative. As such, the third component service 214 may not be actively monitored except as set out below in the discussion with reference to checking for a local optima. Moreover, in the present example, there are no alternative services to the second service 208. The component services utilized by the composite application 204 may be selected either statically or dynamically.

The monitor module 216 may determine the probabilities of breach of the corresponding component services and candidate component services, e.g., by examining historical information corresponding to previous breaches of those services. The monitor module 216 may collect and store breach information or the monitor module 216 may obtain breach information from one or more other modules on the system 200. Based upon the available information, a suitable measure for the probability of breach is selected, such as mean time to failure.

In one exemplary implementation, the monitor module 216 monitors and adjusts the price, penalty and/or component services to maximize overall profit of the system 200. The monitor module 216 achieves the result by developing a probability of breach, e.g., mean time to failure, for each component service and optionally, each candidate component service, Service A1, Service A2, Service A3 and Service B. This allows the system 200 to arbitrate the probability of breach implied by the services price/penalty against the historical breach data that has been accumulated.

The monitor module 216 may also compute the overall probability of breach for the component application 204, e.g., as a function of the probability of breach of the individual service components. By monitoring the overall probability of breach of the composite application 204, the monitor module 216 or other module on the system 200 may better be able to compute expected warranty costs to the composite application 204 and thus better optimize at least one of gross profit, return on investment or other metric of the composite application 204. Accordingly, the monitor module 216 may periodically modify and/or replace component services that comprise the composite application 204.

When the monitor module 216 detects a change in a monitored parameter, e.g., probability of breach, price, penalty or other attribute, a suitable action may be taken. For example, the monitor module 216 may determine that a detected change in probability of breach of a problematic component service requires an action to remediate decreased profit, performance or other actual or perceived impact caused by the detected change. Thus, the monitor module 216 may attempt to negotiate a higher penalty payout by the problematic component service for a failure. The monitor module 216 may also (or alternatively) attempt to negotiate a lower payment to the problematic component service.

Still further, the monitor module 216 may attempt to locate an alternative candidate service to the problematic service. Still further, the composite application 204 may attempt to pass on the additional cost of the problematic component service to the requester 202. For example, the monitor module 216 may implement a reduction in a service guarantee and/or a reduction in the penalty paid to the requestor 202. The price charged by the composite application 204 may also be adjusted. The choice is made to optimize expected economic or performance metric(s) corresponding to the composite application 204. The selected economic or performance metric(s) may thus be treated as a straightforward optimization problem.

As an example, assume that each transaction, e.g., a call to the composite application 204 by a requester 202 has a price of 100 and a penalty of 10 plus the lost revenue. In other words, each time a requestor 202 wishes to utilize the composite application 204, the requester 202 must pay the composite application 204 a price of 100. If the composite application 204 is unable to complete the transaction with the requester 202, then the requester 202 does not have to pay 100 to the composite application 204 and the composite application 204 pays a penalty of 10 to the requester 202.

Keeping with the above example, the first component service 206 may be implemented by one of the candidate services including Service A1, Service A2 and Service A3, but that Service A3 is not currently being considered as a viable candidate. Assume that Service A1 has a price of 10 and a penalty of 1. In other words, Service A1 charges the composite application 204 a price of 10 to conduct a transaction, e.g., implement a role such as by performing a function, computation or other task as part of the composite application 204. If Service A1 is incapable of fulfilling its transaction on behalf of the composite application 204, Service A1 will pay a penalty of 1 to the composite application 204.

Also assume that Service A2 has a price of 15 and a penalty of 2. Thus, Service A2 charges the composite application 204 a price of 15 to conduct a transaction, e.g., implement a role such as by performing a function, computation or other task as part of the composite application 204. However, if Service A2 is incapable of fulfilling its transaction, Service A2 will pay a penalty of 2 to the composite application 204. Still further, assume that Service B has a price of 20 and a penalty of 2. Thus Service B charges the composite application 204 a price of 20 to conduct a transaction, e.g., implement a role such as by performing a function, computation or other task as part of the composite application 204. However, if Service B is incapable of fulfilling its transaction, Service B will pay a penalty of 2 to the composite application 204.

In order to build the composite application assembly, the composite application 204 may start by using the lowest cost candidate component services, Service A1 and Service B in the above example.

In normal operation, the payment from the requestor 202 to the composite application 204 is 100. The cost to the composite application 204 for the use of Service A1 is 10 and the cost to the composite application 204 for the use of Service B is 20 for a total cost of 30 per transaction with the requester 202. Thus, the composite application 204 experiences a profit of 70 for each complete transaction with the requester 202 using Service A1 and Service B. However, a failure in Service A1 would also mean a loss of profit of 70 because the requester 202 only has to pay if a successful transaction with the composite application 204 is completed.

Moreover, the composite application 204 must pay a penalty of 10 to the requester 202 and the composite application 204 may optionally still be required to pay Service B its price of 20. The composite service 204 will receive a credit from Service A1 of 1 (the amount corresponding to the penalty associated with Service A1). Thus, a failure of Service A1 may mean that the composite application 204 will have a loss in profit of 70, an actual payment of 30, including the penalty of 10 to the requester 202 and the payment of 20 to Service B. The composite application 204 will receive a credit from Service A1 of 1 so the composite application 204 has a total loss or warranty cost of 99. Service A1 experiences a loss of profit of 10 and has to pay a penalty to the composite application 204 of 1, so Service A1 has a total loss of 11.

Assume that the composite application 204 decides to use, or wants to consider the use of, the second candidate service 212 for the role of the first component service 206, i.e., Service A2 replaces Service A1. The cost to the composite application 204 for the use of Service A2 is 15 and the cost to the composite application 204 for the use of Service B is 20 for a total cost of 35 per transaction with the requester 202. The composite application still receives the same payment from the requester 202 of 100. Thus, the composite application 204 experiences a profit of 65 for each completed transaction with the requester 202 using Service A2 and Service B.

However, a failure in Service A2 would also mean a loss of profit of 65 because the requester 202 only has to pay if a successful transaction with the composite application 204 is completed. Moreover, as noted above, if the composite application 204 fails to complete its transaction with the requester 202, the composite application 204 must pay a penalty of 10 to the requester 202 and the composite application 204 may still be required to pay Service B its price of 20. The composite service 204 will receive a credit from Service A2 of 2 (the amount corresponding to the penalty associated with Service A2). Thus, a failure of Service A2 means that the composite application 204 will have a loss in profit of 65, an actual payment of 30, including the penalty of 10 to the requester 202 and the payment of 20 to Service B. The composite application 204 will receive a credit from Service A2 of 2 so the composite application 204 has a total loss or warranty cost of 94. Service A2 experiences a loss of profit of 15 and has to pay a penalty to the composite application 204 of 2, so Service A2 has a total loss of 17.

As one exemplary implementation, an economic metric is determined to select between Service A and Service B based upon the corresponding probability of breach of Service A1 in relation to the probability of breach of Service A2.

Let POB_A1 designate the probability of breach of Service A1 and POB_A2 designate the probability of breach of Service A2.

In general, the expect value is the expected payment−the expect penalty. More specifically, the expected value is:

[the payment price received by the composite application if there is no failure−the cost of providing the transaction*the probability of non-breach (which is 1-POB)]−[composite application penalty−refund*probability of breach]

So, for Service A1:

[(100−10)*(1-POB_A1)]−[(10−1)*POB_A1]−20

This assumes that Service B gets paid, even if the composite application fails to complete the transaction with the requester. Further, the (10−1) term means that the composite application pays 10 to Service A if Service A completes its role, but gets 1 back if Service A cannot complete its role.

=90*(1-POB_A1)]−9*POB_A1−20

=90−90POB_A1−9POB_A1−20

=70−99POB_A1

For A2, it is:

[(100−15)*(1-POB_A2)]−[(10−2)*POB_A2]−20

This also assumes that Service B gets paid, even if the composite application fails to complete the transaction with the requester.

=85−85POB_A2−8 POB_A2−20

=65−93POB_A2

So, to select A1, you want the below inequality to be true:

70−99POB_A1>65−93POB_A2

99POB_A1>−93POB_A2−5

99POB_A1<93POB_A2+5

POB_A1<(93POB_A2+5)/99

Depending on the exact assumptions made, e.g., whether the composite application has to pay B in the event of a failure, for example, even the same metrics may come out slightly different, even given the same parameters

Assume as an example, that the observed historical probability of breach of Service A1 is 98.9% or greater. Under this condition, Service A1 should be used. If the observed historical probability of breach of Service A1 is less than 98.9%, then the historical probability of breach of each of Service A1 and A2 must be considered.

As another example, assume that the historical probability of breach of Service A2 is 75%. Under this condition, if the historical probability of breach of Service A1 is greater than approximately 75.5%, then Service A1 should be used, otherwise Service A2 should be used.

Assume again that the first component service 206 is implemented by Service A1. If the monitor module 216 detects that Service A1 is problematic, e.g., its monitored probability of breach has changed relative to its historical probability of breach, the system may attempt to negotiate a higher penalty payment from Service A1 in response to a breach. The system may also lower the amount it is willing to pay to Service A1. Still further, the system may attempt to locate an alternative provider of that service, for example using a service desk or other appropriate means to locate an appropriate replacement service. In the above example, if profit justifies the change, the composite application may replace Service A1 with Service A2 to implement the first component service 206. Still further, the system may attempt to lower its service guarantee and/or modify its penalty paid to the requester 202. Any combination of remedies or actions may also be implemented. For example, the system 200 may alter its penalty to Service A1 from 1 to 2 and change its service guarantee to the requester 202 if that combination would be more profitable than changing from Service A1 to Service A2. Such decisions may consider not only the price and penalties of the respective services, but also the historical probabilities of breach of the respective services.

In one exemplary implementation, the choice of addressing the problematic component service is made to optimize an economic measure attained by the composite application, with particular focus on optimizing the arbitrage potential.

The monitor module 216 may also periodically sample new candidate services. For example, the monitor module 216 may periodically sample Service A3 to ensure that the system does not stick in a local optima. For example, the third candidate service 216 may be available for implementing the functions of the first component service 206. However, the monitor to 216 may have determined that the probability of breach, price, penalty and/or other characteristics of using Service A3 did not justify it as a viable candidate for use in the system 200. However, it is possible that service A3 may be improved over time such that it's probability of breach, price, penalty, features or other characteristics change in a manner that makes it a viable candidate for use in implementing the functions of the first component service 206. Accordingly, even though Service A3 is not currently in use, it is periodically checked by the monitor module to 216 to make sure that the historical basis for not using Service A3 is still valid.

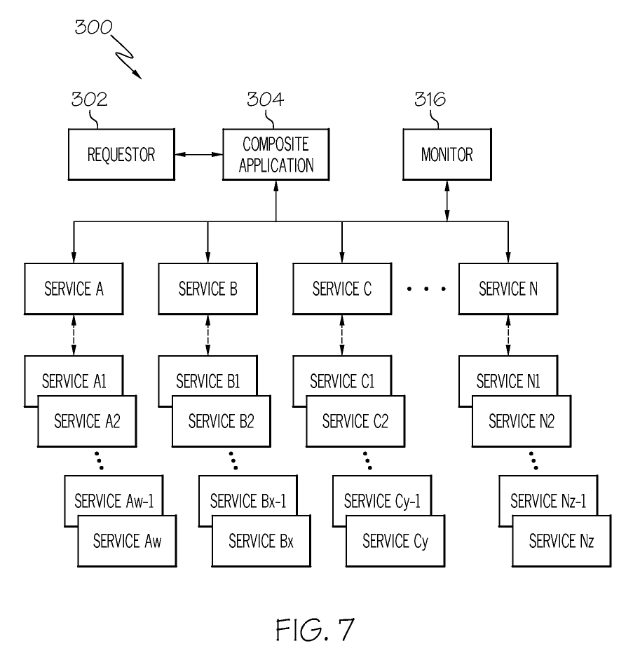

Referring to FIG. 7, the concepts herein can be expanded to accommodate any number of component services and any number of candidate component services. For example, in the system 300, a requestor 302 transacts with a composite application 304. The composite application is assembled from N component services, where N is any integer. Each service (A-N) may have any number of candidate component services. Thus, as shown, Service A may be selected from the candidate component services Service A1-Service Aw where w is any integer. Service B may be selected from the candidate component services Service B1-Service Bx where x is any integer. Service C may be selected from the candidate component services Service C1-Service Cy where y is any integer. The above concepts can be repeated by analogy up to Service N, which may be selected from the candidate component services Service N1-Service Nz where z is any integer. The monitor 316 monitors the composite application 304, the component services A-N as well as the candidate services and the system, e.g., via the monitor 316 or other suitable processing device, maximizes the profit of the composite application 304 using any of the techniques described more fully herein.

The present invention is described below with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

Other computer system configurations can also be employed to perform the method of this invention, and to the extent that a particular system configuration is capable of performing the method of this invention, it is equivalent to the representative computer system and within the scope of this invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer-implemented method of assembling an application comprising:
monitoring at least one component service of a composite application;
determining a probability of breach for at least one monitored component service of said composite application;
computing an economic or performance metric corresponding to said composite application based upon at least one determined probability of breach; and
performing an action if a determination is made that said economic or performance metric of said composite application should be improved, said action comprising at least one of:
adjusting at least one parameter associated with said composite application or monitored service, or
replacing one or more component services utilized by said composite application.

2. The method according to claim 1, further comprising:
for at least one monitored component service:
storing historical probability of breach data;
identifying a price paid to said component service for completion of a corresponding predetermined transaction; and
identifying a penalty paid by said component service for failure to complete said corresponding predetermined transaction;
wherein said performing an action if a determination is made that said economic or performance metric of said composite application should be improved further comprises arbitraging a probability of breach implied by said component service price and penalty against its historical probability of breach data.

3. The method according to claim 1, wherein performing an action if a determination is made that said economic or performance metric of said composite application should be improved further comprises:
determining a warranty cost for said composite application for failure of said composite application to complete a transaction with a requestor; and
adjusting at least one of component service selection, component service price and component service penalty.

4. The method according to claim 1, further comprising:
detecting a problematic service from said at least one monitored service; and
performing a correction comprising at least one of negotiating a higher penalty for said problematic service and attempting to locate an alternative provider for said problematic service.

5. The method according to claim 1, wherein:
said composite application comprises a service guarantee to requesters of said composite application, and further comprising:
performing a correction comprising reducing said service guarantee.

6. The method according to claim 1, wherein:
said composite application comprises a failure of service penalty paid to requestors of said composite application for failure of said composite application to successfully complete a transaction with said corresponding requestor; and
further comprising:
performing a correction comprising reducing said failure of service penalty.

7. The method according to claim 1, wherein:
said composite application comprises a service guarantee to requesters of said composite application and a failure of service penalty paid to requesters of said composite application for failure of said composite application to successfully complete an interaction with a corresponding requester;
further comprising:
detecting a problematic service from said at least one monitored service; and
performing a correction comprising at least one of:
negotiating a higher penalty for said problematic service, attempting to locate an alternative provider for said problematic service, reducing said service guarantee and reducing said failure of service penalty, wherein said correction is selected to optimize expected economic metric attained by said composite application.

8. The method according to claim 7, wherein said correction optimization balances gross profit and return on investment to said composite application.

9. The method according to claim 1, further comprising periodically sampling a new service to update candidate component services that can be integrated into said component application.

10. A computer program product to monitor an application assembly comprising:
a computer usable medium having computer usable program code embodied therewith, the computer usable program code comprising:
computer usable program code configured to monitor at least one component service of a composite application;
computer usable program code configured to determine a probability of breach for at least one monitored component service of said composite application;
computer usable program code configured to compute an economic or performance metric corresponding to said composite application based upon at least one determined probability of breach; and
computer usable program code configured to perform an action if a determination is made that said economic or performance metric of said composite application should be improved, said action comprising at least one of:
an adjustment of at least one parameter associated with said composite application or monitored service, or
a replacement of one or more component services utilized by said composite application.

11. The computer program product according to claim 10, further comprising:
computer usable program code configured for at least one monitored component service to:
store historical probability of breach data;
identify a price paid to said component service for completion of a corresponding predetermined transaction; and
identify a penalty paid by said component service for failure to complete said corresponding predetermined transaction;
wherein said computer usable program code configured to perform an action if a determination is made that said economic or performance metric of said composite application should be improved further comprises:
computer usable program code configured to arbitrage a probability of breach implied by said component service price and penalty against its historical probability of breach data.

12. The computer program product according to claim 10, wherein said computer usable program code configured to perform an action if a determination is made that said economic or performance metric of said composite application should be improved further comprises:
computer usable program code configured to determine a warranty cost for said composite application for failure of said composite application to complete a transaction with a requestor; and
computer usable program code configured to adjust at least one of component service selection, component service price and component service penalty.

13. The computer program product according to claim 10, further comprising:
computer usable program code configured to detect a problematic service from said at least one monitored service; and
computer usable program code configured to perform a correction comprising at least one of negotiating a higher penalty for said problematic service and attempting to locate an alternative provider for said problematic service.

14. The computer program product according to claim 10, further comprising:
computer usable program code configured to associate said composite application with a service guarantee to requesters of said composite application, and
computer usable program code configured to perform a correction comprising reducing said service guarantee.

15. The computer program product according to claim 10, further comprising:
computer usable program code configured to implement a failure of service penalty paid to requestors of said composite application by said composite application for failure of said composite application to successfully complete a transaction with said corresponding requestor; and
computer usable program code configured to perform a correction comprising reducing said failure of service penalty.

16. The computer program product according to claim 10, further comprising:
computer usable program code configured to implement a service guarantee by said composite application to requesters of said composite application and a failure of service penalty paid to requesters of said composite application for failure of said composite application to successfully complete an interaction with a corresponding requester;
computer usable program code configured to detect a problematic service from said at least one monitored service; and
computer usable program code configured to perform a correction comprising at least one of negotiating a higher penalty for said problematic service, attempting to locate an alternative provider for said problematic service, reducing said service guarantee and reducing said failure of service penalty, wherein said correction is selected to optimize expected economic metric attained by said composite application.

17. The computer program product according to claim 16, wherein said correction optimization balances gross profit and return on investment to said composite application.

18. The computer program product according to claim 10, further comprising computer usable program code configured to periodically sample a new service to update candidate component services that can be integrated into said component application.

19. A system to monitor an application comprising:
a module to monitor at least one component service of a composite application;
a module to determine a probability of breach for at least one monitored component service of said composite application;
a module to compute an economic or performance metric corresponding to said composite application based upon at least one determined probability of breach; and
a module to perform an action if a determination is made that said economic or performance metric of said composite application should be improved, said action comprising at least one of:
an adjustment of at least one parameter associated with said composite application or monitored service, or
a replacement of one or more component services utilized by said composite application.

20. The system according to claim 19, further comprising:
for at least one monitored component service, a module to:
store historical probability of breach data;
identify a price paid to said component service for completion of a corresponding predetermined transaction; and
identify a penalty paid by said component service for failure to complete said corresponding predetermined transaction;
wherein said module to perform an action if a determination is made that said economic or performance metric of said composite application should be improved arbitrages a probability of breach implied by said component service price and penalty against its historical breach probability of breach data.

21. The system according to claim 19, wherein said module to perform an action if a determination is made that said economic or performance metric of said composite application should be improved further comprises:
a module to determine a warranty cost for said composite application for failure of said composite application to complete a transaction with a requester; and
a module to adjust at least one of component service selection, component service price and component service penalty.

22. The system according to claim 19, further comprising:
a module to detect a problematic service from said at least one monitored service; and
a module to perform a correction comprising at least one of negotiating a higher penalty for said problematic service and attempting to locate an alternative provider for said problematic service.

23. The system according to claim 19, wherein:
said composite application comprises a service guarantee to requestors of said composite application, and further comprising:
a module to perform a correction comprising reducing said service guarantee.

24. The system according to claim 19, wherein:
said composite application comprises a failure of service penalty paid to requesters of said composite application for failure of said composite application to successfully complete a transaction with said corresponding requester; and
further comprising:
a module to perform a correction comprising reducing said failure of service penalty.

25. The system according to claim 19, wherein:
said composite application comprises a service guarantee to requestors of said composite application and a failure of service penalty paid to requestors of said composite application for failure of said composite application to successfully complete an interaction with a corresponding requestor;
further comprising:
a module to detect a problematic service from said at least one monitored service; and
a module to perform a correction comprising at least one of negotiating a higher penalty for said problematic service, attempting to locate an alternative provider for said problematic service, reducing said service guarantee and reducing said failure of service penalty, wherein said correction is selected to optimize expected economic metric attained by said composite application.

26. The system according to claim 25, wherein said correction optimization balances gross profit and return on investment to said composite application.

27. The system according to claim 19, further comprising a module to periodically sample a new service to update candidate component services that can be integrated into said component application.
